(19) United States
(12) Patent Application Publication
(10) Pub. No.: US 2024/0399246 A1
(43) Pub. Date: Dec. 5, 2024

(54) Systems and Methods for Ongoing Reconciliation of Network Game Data for Almost-Deterministic Client and Server

(71) Applicant: Six Impossible Things Before Breakfast Limited, Dublin (IE)

(72) Inventors: Sherry IGNATCHENKO, Weidling (AT); Dmytro IVANCHYKHIN, Kiev (UA)

(73) Assignee: Six Impossible Things Before Breakfast Limited, Dublin (IE)

(21) Appl. No.: 18/733,302

(22) Filed: Jun. 4, 2024

Related U.S. Application Data
(60) Provisional application No. 63/506,196, filed on Jun. 5, 2023.

(51) Int. Cl. A63F 13/358; A63F 13/355; A63F 13/52

(52) U.S. Cl. CPC A63F 13/358; A63F 13/355; A63F 13/52

(57) ABSTRACT

Systems and methods for updating and maintaining a game state at a game client based on information provided by a game server are disclosed herein. The systems and methods described herein may enable a game client (or client computer system) to perform ongoing reconciliation in an almost-deterministic system. In various implementations, instead of consistently providing updated game state data, the game server may publish aggregated information calculated based on only a portion of the updated game state data that may be used by a game client to perform ongoing reconciliation of simulations performed on the game client and simulations performed on the game server. In some implementations, the aggregated information may comprise a hash calculated based on the updated game state data. In some implementations, the aggregated information published by the game server may relate to a particular grouping of information representing a portion of the updated game state data.

### RELATED APPLICATIONS

This application claims priority to U.S. Provisional Application No. 63/506,196, entitled “Method for Ongoing Reconciliation of Network Game Data for Almost-Deterministic Client and Server,” filed on Jun. 5, 2023, the content of which is hereby incorporated herein by reference in its entirety.

### FIELD OF THE DISCLOSURE

The systems and methods described herein relate to improved techniques for updating and maintaining a game state rendered at a game client based on information received from a game server.

### BACKGROUND

In three-dimensional online games, various game assets are frequently used to express computer-generated graphics or three-dimensional models. Game assets include different three-dimensional objects such as characters, items, cars, furniture, buildings, or other structures. Most of the time, game assets are incorporated into the three-dimensional online games and are downloaded when players decide to purchase games. As the complexity and detail of game assets in online games increases (for example, to accommodate the use of augmented or virtual reality), maintaining an adequate download and loading-to-screen time becomes increasingly difficult. Indeed, as the size of the game assets increases, so too does transmission data size, transmission time, memory usage, and rendering time. Similarly, the size of the transmissions required for a game server to continuously update an online game at a game client has also increased as the complexity and detail of online games has increased.

In online games, the simulation of game activity often relies on all simulation nodes to be completely deterministic and work in sync with each other. This means that simulations may be strictly run on a game server, or at the very least, not at the game client. While this approach may have benefits when used in multiplayer games (as only inputs are and need be synchronized), it also suffers from major drawbacks. For example, strictly deterministic systems are bound by the slowest node (or the node with the worst connectivity) and can also be difficult to achieve. Alternative approaches, which may utilize dead reckoning and/or client-side prediction, use client-side simulation to shift the performance of certain gameplay logic to the game client. These approaches require performing reconciliation and are intended for relatively short spans of time, as it is essential to prevent errors from accumulating, which in turn may cause major discrepancies between a game server and the game client.

In light of the foregoing, there is a need for improved systems or techniques for updating and maintaining a game state at a game client based on information provided by a game server.

### SUMMARY OF THE DISCLOSURE

This disclosure relates to systems and methods for updating and maintaining a game state at a game client based on information provided by a game server. The systems and methods described herein may enable a game client (or client computer system) to perform ongoing reconciliation in an almost-deterministic system. In various implementations, a game server publishes game state data related to a first point in time for use by one or more client computer systems to render a virtual scene within an online game. Using the published game state data, a game client may be configured to render the corresponding virtual scene. The game client may also simulate game activity for one or more subsequent points in time based on the published game state data and render virtual scenes based on the simulated game activity. In some implementations, the game client may be restricted to only simulating and rendering game activity that includes (or does not include) certain types of occurrences. For example, the game client may be prohibited from rendering the types of outcomes and developments within an online game that cause major changes from the perspective of the player. The game server will also simulate game activity for one or more subsequent points in time. In some implementations, the game server may not provide updated game state data for the subsequent points in time, thus allowing the game client to rely on the simulations performed at the game client. Instead, the game server may publish aggregated information calculated based on only a portion of the updated game state data to enable the game client to perform ongoing reconciliation of the simulations performed on the game client and the simulations performed on the game server.

According to one aspect of the invention, the aggregated information published by the game server may comprise one or more hashes calculated based on the updated game state data. For example, the hash may comprise a Fletcher checksum, a CRC checksum, a cryptographic hash function (such as SHA-256, SHA-3, or Blake2), and/or other types of hashes described herein or known to those with skill in the art. In various implementations, the hash may comprise a concatenation of multiple hash values. For example, the hash may comprise a concatenation of at least first and second hash values calculated based on the updated game state data. In some implementations, a concatenation of hash values may include hash values calculated over data which itself is calculated using different rounding techniques (e.g., rounding vs. truncating and/or using different delta values for rounding/truncation as described herein). For example, calculating a first hash value may include truncating or rounding individual field values after adding a first delta, and calculating a second hash value may include truncating or rounding the individual field values after adding a second delta. In some implementations, the game server may calculate hash values within a concatenation of hash values using different radixes. For example, a first hash value may be calculated over at least one field value represented using a first radix of representation, and a second hash value may be calculated over the at least one field value represented using a second radix of representation. In such implementations, each radix of representation may comprise a co-prime radix. In various implementations, when comparing concatenated hash values, if any of two concatenated hash values are the same, the hash values may be considered to be the same.

In some implementations, the simulated game activity may be represented in floating-point. In some such implementations, the game server may convert the floating-point representations to fixed-point representations before the hash is calculated based on the simulations performed on the game server. In various implementations, the game sever may calculate the hash over a pre-defined number of digits or bits of fields representing a game state at one or more subsequent points in time. For example, the pre-defined number of digits (or bits) may comprise a set of most-significant digits or bits.

According to another aspect of the invention, the aggregated information published by the game server may relate to a particular grouping of information representing a portion of the updated game state data. The game server may be configured to publish aggregated information on a per-group basis over time. The groupings of information may be utilized to narrow down (and identify) discrepancies between simulations performed on the game client and the simulations performed on the game server. In response to identifying a discrepancy using the aggregated information, the game client may issue a reconciliation request to the game server. In some implementations, the reconciliation request may identify a discrepancy by including an indication of a pre-defined sub-grouping of the grouping of information included in the aggregated information. For example, the game client itself may calculate aggregated information based on the pre-defined sub-grouping and include the aggregated information in the reconciliation request. In response to the reconciliation request, the game server may provide a reply that includes information sufficient to reconcile the discrepancy between the simulations performed on the client computer system and the aggregated information.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to update and maintain a game state based on information provided by a game server, according to one or more aspects described herein;

FIG. 2 depicts a diagram of an example of a method for updating a game state based on information received from a game server, according to one or more aspects described herein; and

FIG. 3 depicts a diagram of an example of a method for providing information related to a game state necessary to perform ongoing reconciliation of simulations performed at a game client, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

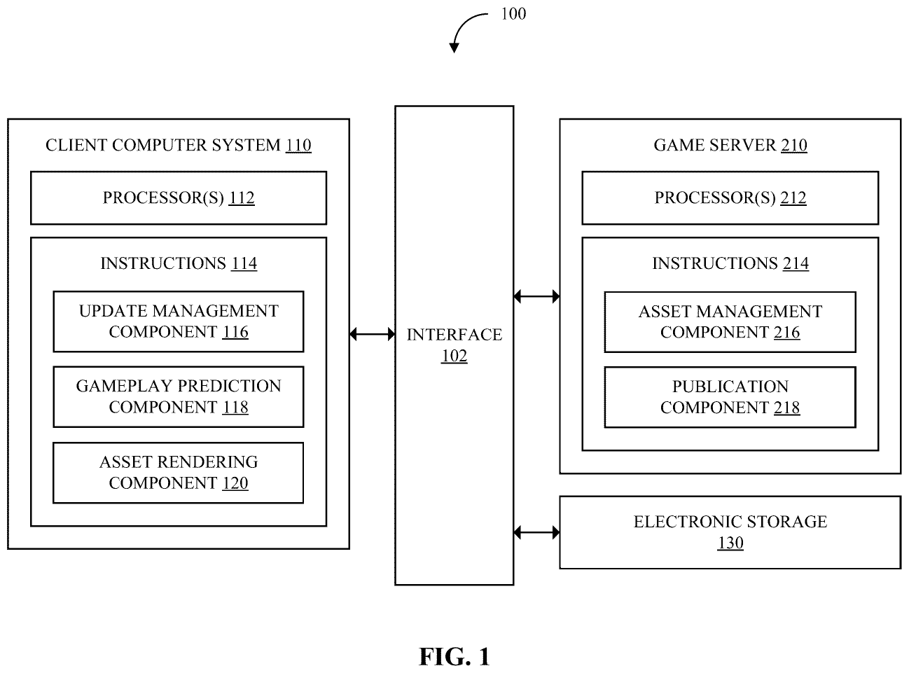

FIG. 1 depicts a block diagram of an example of a system 100 configured to update and maintain a game state based on information provided by a game server, according to one or more aspects described herein. In various implementations, the information comprises game state data that may be used by a game client to render three-dimensional objects within a virtual scene in an online game. In various implementations, system 100 may include one or more of an interface 102, at least one client computer system 110, electronic storage 130, a game server 210, and/or other components. In various implementations, client computer system (or device) 110 may comprise a game client computing system (or device). In some implementations, client computer system 110 may be configured to receive instructions and game state data from game server 210 related to an online game comprising three-dimensional virtual scenes. Notably, while “three-dimensional objects” and “three-dimensional virtual scenes” are referred to herein, the techniques described herein may apply equally to “two-dimensional objects” and “two-dimensional virtual scenes.” As such, all references herein to “three-dimensional objects” and “three-dimensional virtual scenes” may be replaced with “two-dimensional objects” and “two-dimensional virtual scenes,” respectively. In various implementations, client computer system 110 may include one or more physical processors 112 (also interchangeably referred to herein as processor(s) 112, processor 112, or processors 112 for convenience), computer readable instructions 114, and/or one or more other components. In various implementations, game server 210 may include one or more physical processors 212 (also interchangeably referred to herein as processor(s) 212, processor 212, or processors 212 for convenience), computer readable instructions 214, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via client computer system 110 and/or game server 210.

In various implementations, processor(s) 112, 212 may be configured to provide information processing capabilities in system 100. As such, the processor(s) 112, 212 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112, 212 may be configured to execute one or more computer readable instructions 114, 214. Computer readable instructions 114, 214 may include one or more computer program components. In various implementations, computer readable instructions 114 may include one or more of update management component 116, gameplay prediction component 118, asset rendering component 120, and/or one or more other computer program components, and computer readable instructions 214 may include one or more of asset management component 216, publication component 218, and/or other computer program components. As used herein, for convenience, the various computer readable instructions 114, 214 will be described as performing an operation, when, in fact, the various instructions program the processor(s) 112, 212 (and therefore client computer system 110 or game server 210) to perform the operation.

In various implementations, client computer systems 110 may subscribe to receive game updates from a game server 210 related to an online game. For example, game server 210 may “publish” game state, and one or more of client computer system 110 may “subscribe” to receive the published game state. As a result of such a “subscription” by a client computer system 110, game server 210 may (a) send client computer system 110 a current game state, (b) include client computer system 110 (identified, for example, by its IP address and/or network socket which is used to communicate with client computer system 110) on a list of “subscribers” for this “publication”, and (c) whenever published game state is updated (for example, as a result of user inputs sent to the game server and/or as a result of simulation), game server 210 may send the update to the game state to all the current “subscribers.” In response to the updated game state data and/or as otherwise necessary, client computing system 110 may be configured to download game assets from game server 210 for rendering within virtual scenes of the game. To that end, in various implementations, asset management component 216 may be configured to generate, organize, encode, and/or otherwise manage game assets used to render a virtual scene. For example, game assets may comprise the three-dimensional objects that, when rendered, make up a virtual scene in a game.

In various implementations, asset management component 216 may be configured to save digital assets. For example, to do so, in various implementations, asset management component 216 may be configured to utilize any of the one or more compression methods described in U.S. patent application Ser. No. 18/630,409, entitled “SYSTEMS AND METHODS FOR INCREMENTAL DYNAMIC LOADING OF GAME ASSETS,” filed Apr. 9, 2024, the contents of which are hereby incorporated by reference herein in their entirety. In some implementations, asset management component 216 may be configured to utilize any of the one or more compression methods described in U.S. patent application Ser. No. 18/630,409, with minor modifications. In various implementations, asset management component 216 may be configured to save digital assets in a “decompression-friendly” format. For example, when compressing a texture, the “decompression-friendly” format may comprise a modified version of JPEG or JPEG XL format (or any other format from the JPEG family), as described in U.S. patent application Ser. No. 18/630,409.

In various implementations, publication component 218 may be configured to publish data regarding a current state of the game. In various implementations, publication component 218 may be configured to use mechanisms such as Unity sync variables, UE4 variable replication, or ZeroMQ or global-mq “publications.” In various implementations, a publication may include one or more of the following: a current level, list of items and/or non-player characters (NPCs) with identifiers for their three-dimensional models and/or their coordinates. In some implementations, a publication may be compressed using compression methods for structured data. For example, a given publication may be compressed using one or more techniques described in U.S. patent application Ser. No. 18/438,702, entitled “SYSTEMS AND METHODS FOR IMPROVING COMPRESSION OF STRUCTURED DATA IN THREE-DIMENSIONAL APPLICATIONS,” filed Feb. 12, 2024, the content of which is hereby incorporated by reference herein in its entirety.

In various implementations, publication component 218 may be configured to use UDP as a transport protocol to synchronize “subscription” on the client-side (i.e., at client computer systems 110) with a “publication” on the server-side (i.e., at game server 210). In some implementations, publication component 218 may be configured to send updated game state data (or “updates”) as “publication” within UDP packets. In such implementations, publication component 218 may be configured to send updated game state data within UDP packets at regular intervals. The moments of such updates (i.e., at regular intervals) may be referred to as a “network ticks.” Typically, movements are simulated within an online game at the same time that an update is published. The moments when movements are simulated within an online game may be referred to as “simulation ticks.” Typically, “simulation ticks” occur at the same time as “network ticks.” In some implementations, however, simulation ticks may occur at a different frequency than network ticks. For example, there may be several simulation ticks per network tick. Moreover, as described herein, there may be implementations without network ticks (“tick-less game state publications”) while simulation ticks may still be present.

In various implementations, game state data provided by game server 210 (e.g., in a “publication”) may include coordinate data, velocity data, moment data, and/or other information as described, for example, in U.S. patent application Ser. No. 18/669,729, entitled “SYSTEMS AND METHODS FOR TICK-LESS UDP GAME TRAFFIC,” filed May 21, 2024, the content of which is hereby incorporated by reference herein in its entirety. In some implementations, moment data included in game state data may comprise “TObj,” which indicates the moment in time to which coordinate data and velocity data correspond. In some implementations, coordinate data included in game state data may denote coordinates of the object as of the moment TObj. In some implementations, velocity data included in game state data may comprise (or indicate) one or more of a velocity of the object as of the moment TObj and a “velocity profile,” which may be associated with a current movement by the object as described further in U.S. patent application Ser. No. 18/669,729. In various implementations, game state data may provide information indicating a status of a game world at a given time. In other words, game state data may provide information indicating a “game world state.”

In various implementations, publication component 218 may be configured to send updated game state data (i.e., update a “publication,” for example, by sending UDP packets) at irregular intervals. For example, publication component 218 may not update a publication at a regular interval (such as at a “network tick”), but may instead update a publication whenever it becomes necessary. In some such implementations, publication component 218 may be configured to send updated game state data on a simulation tick, in response to inputs coming from users, in response to inputs coming from artificial intelligence or other CPU-controlled entities (collectively referred to herein as “AI”), on timer events happening at pre-defined intervals following inputs from players and/or AI, and/or in response to other events. This may allow game server 210 (or publication component 218) to send information about a change in the game state (i.e., send updated game state data), which may be caused, for example, by another player pressing a button, not only at a next network tick, but instead as soon as game server 210 learns about the change. Such embodiments may be referred to herein as “tick-less,” and are described further in U.S. patent application Ser. No. 18/669,729. Using a tick-less approach may result in a reduction in perceived lag, which is the delay between an action occurring and the same action being displayed to a user at a game client (e.g., client computer system 110). In some implementations, even if updates are not sent at network ticks, game server 210 may still be configured to use “virtual ticks,” which may correspond to regular intervals on game server 210 and client computer system 110, but do not directly correspond to a time when packets are sent.

In various implementations, update management component 116 may be configured to manage updates and other information received by client computer system 110 from game server 210. In various implementations, gameplay prediction component 118 may be configured to predict (or calculate) information (such as the coordinates or velocity) of an object based on information received from game server 210. For example, gameplay prediction component 118 may be configured to determine velocity and/or coordinates of individual object(s) at a given time using information received by client computer system 110 from game server 210 using calculations or simulation, as described in U.S. patent application Ser. No. 18/669,729. In various implementations, asset rendering component 120 may be configured to render game assets within a virtual scene.

In various implementations, the same calculations (which may involve simulations) may be performed on both the client computer system 110 and on game server 210. For example, gameplay prediction component 118 may be configured to use game state data related to a moment TObj to predict a velocity and coordinates for an object at subsequent points in time. In some implementations, game server 210 may be configured to forgo sending updated game state data if previous game state data provided to a client computer system 110 includes all the information necessary to calculate a position of an object at an arbitrary future point in time. In order to do so, game server 210 may be configured to perform the same calculations and/or simulations as the client computer system 110 using the previously provided game state data related to a moment TObj and compare a predicted velocity and coordinates for an object at a subsequent point time with a known velocity and coordinates for that object at that subsequent point in time. Nevertheless, game server 210 may still need to publish updates relevant to changes to the published state introduced by other players.

In some implementations, the calculations performed on client computer system 110 and game server 210 (or the results of these calculations) may have to be exactly the same. In other words, simulations on both sides may have to be fully (or “strictly”) deterministic. Unlike with lockstep algorithms, however, any strict deterministic approaches may not be necessary because it would be difficult, more specifically, for cross-platform clients when floating-point calculations are used. In some such implementations, client computer system 110 may be configured to reconcile between an already-rendered state and updated game state data (issued by game server 210 as a publication and implemented in client computer system 110 as a corresponding subscription). For example, in some implementations, to avoid abrupt movements of an object, client computer system 110 may be configured to blend (or combine) an old (i.e., already-rendered) trajectory with a new (i.e., updated from the subscription) trajectory. In other implementations, client computer system 110 may be configured to use any of the methods for reconciling between an already-rendered state and updated game state data described in “Development and Deployment of Multiplayer Online Games, Vol. I: GDD, Authoritative Servers, Communications (Development and Deployment of Multiplayer Games)” by “No Bugs” Hare, translated by Sergey Ignatchenko, and published Jul. 1, 2017, and/or in “Fast-Paced Multiplayer (Part IV): Lag Compensation” by Gabriel Gambetta, available at https://www.gabrielgambetta.com/lag-compensation.html (last visited May 14, 2024), the content of each of which is hereby incorporated by reference herein in its entirety. In some implementations, a publisher (or game server 210) may publish some (but not necessarily all) simulated updates, so that when reconciliation occurs, accumulated errors based on different calculations from client computer system 110 and game server 210 do not cause observable visual effects.

In various implementations, system 100 may permit client-side simulations (or simulations performed by client computer system 110) to be treated as “almost-deterministic” with respect to server-side simulations (or simulations performed by game server 210). For example, the same code (in same programming language or different programming languages) may be run on both game server 210 and client computer system 110, but efforts to achieve the exact same results on both sides down to the last bit may be avoided. In such instances, the results will be almost the same, but are not guaranteed to be exactly the same. In particular, this approach avoids efforts to achieve so-called “floating-point determinism,” which is known to be extremely difficult in the presence of different CPUs, different platforms, different libraries, and so on. Ultimately, under the approach described further herein, simulation results on client computer system 110 and on game server 210 will always be “almost the same.”

While usually such minor discrepancies do not cause problems when they first occur, the discrepancies tend to accumulate, which in turn may result in a discrepancy large enough to cause different outcomes of the game from the perspective of client computer system 110 and game server 210. For example, a bullet may hit the target in a simulation run on game server 210, buy may miss in a simulation run on client computer system 110. Thus, while the systems and methods described herein may allow the game to run slightly differently on client computer system 110 and on game server 210 (which may avoid the trouble of trying to achieve strict determinism), the techniques described herein enable any major discrepancies between client computer system 110 and game server 210 to be avoided.

In various implementations, game occurrences (which may also be referred to interchangeably herein as “game outcomes” or “game developments”) may be classified as either “soft” or “hard” game occurrences. “Soft” occurrences comprise outcomes or developments within a game that do not cause any major changes from the player's perspective. For example, soft occurrences may include movements, a change to a health attribute of a player character (PC) or non-player character (NPC), and/or other similar game outcomes or developments. “Hard” occurrences comprise outcomes or developments within a game that do cause major changes from the player's perspective. For example, hard occurrences may include such things as “falling down the cliff” or “dying because PC/NPC health went too low.” Notably, while an accumulation of soft occurrences may ultimately lead to (or amount to) a hard occurrence, a distinction can still be made between soft occurrences and hard occurrences. Another way to view the difference between soft occurrences and hard occurrences is based on whether reconciliation of the occurrence will look plausible for the player. For soft occurrences, reconciliation can be made to look plausible. For example, if an NPC coordinate is 0.2 mm off, for most games it is unlikely to meaningfully affect a user's experience. To the contrary, for hard occurrences, reconciliation will not look plausible, and thus may meaningfully affect a user's experience (and the game itself). For example, reconciling an erroneous fall off a cliff would require bringing the character back to the edge of the cliff. Accordingly, system 100 may permit client computer system 110 to perform calculations and run simulations that result in soft occurrences within a game, but require that hard occurrences within a game be corroborated by or based on game state data provided by game server 210.

In various implementations, ongoing reconciliation may be used to prevent rounding errors (or, more generally, errors due to system 100 permitting almost-determinism instead of strict determinism) from accumulating to cause significant visual differences. In various implementations, game server 210 may be configured to publish on an ongoing basis (e.g., via publication component 218) some but not all updated game state data to be potentially included in publications for particular moments in time. If client computer system 110 determines, based on the data provided by game server 210, that the game world state from the perspective of game server 210 differs from the game world state from the perspective of client computer system 110, client computer system 110 may be configured to reconcile an already-rendered state with the game world state from the perspective of game server 210.

Notably, client computer system 110 may be configured to perform calculations and/or run simulations on game state data provided by game server 210 to avoid game server 210 having to consistently provide updated game state data in order to reduce network traffic. Network traffic may also be reduced by game server 210 avoiding passing data indicating an entire game world state at any one point in time. Thus, in some implementations, game server 210 may be configured to send in a publication comprising game packets (or a game stream) data for only one or more fields at a time for the purposes of performing ongoing reconciliation. For example, if a dozen characters (PCs or NPC) are moving within a virtual scene, game server 210 may be configured to send information (or data) in each packet indicating the current state of one object (e.g., a velocity and/or coordinates for that one object). Even if data for more than one object is provided, game server 210 may be configured to avoid sending all possible game state (e.g., the velocities and coordinates for the characters moving within a virtual scene), instead distributing that data over a period of time. In such implementations, client computer system 110 may be configured to determine whether a current value of a received field is an exact match with its own representation at that same moment of server time. If it is not an exact match (e.g., because of a rounding error), client computer system 110 may be configured to perform reconciliation (i.e., by reconciling the already-rendered state with a corresponding game world state based on at least the field received from game server 210).

In various implementations, game server 210 may be configured to send information based on one or more groupings of objects. For example, objects within a scene may be split into one or more groups that are known to both game server 210 and client computer system and/or may be communicated between them over a network (e.g., via interface 102). In some implementations, groups may be not over object boundaries, but using different criteria. For example, one group may include all the X components of object velocities in a scene. In some implementations, groups may further include sub-groups (including a hierarchy of groups and/or sub-groups).

In various implementations, game server 210 may be configured to calculate aggregate information (which may also be referred to interchangeably herein as “aggregated information”) over the fields of the objects that belong to a certain group. For example, aggregate information may be for all the field of all the objects in that group. In various implementations, the aggregate information may be sent instead of an entire set of updated game state data. In some implementations, the aggregate information may be a hash. For example, the hash may be based on any appropriate hash function including, but not limited to, Fletcher checksum, Adler checksum, a cyclic redundancy check (CRC), and/or any appropriate crypto-hash including any hashes based on any secure hashing algorithm (SHA), BLAKE, Keccak, and/or any other appropriate crypto-hash. In some implementations, game server 210 may be configured to calculate a hash in an incremental manner, such that changes to a hash may be calculated based on change to a certain field without re-calculating an entire hash.

In some implementations, game server 210 may be configured to calculate a hash over only a pre-defined number of most-significant bits (or, more generally, a pre-defined number of most-significant digits using any pre-defined radix). For example, if floating-point numbers are used for simulations, game server 210 may be configured to convert floating-point numbers to fixed-point representations (which may include integer representations), before taking most-significant bits and calculating a hash. This alone may permit a certain degree of discrepancy without any corrective action. For example, if a coordinate for an NPC is 0.2 mm off (similar to the example provided above), this discrepancy may not be worth reconciling. In addition, this may allow ongoing reconciliation to work over different representations on client computer system 110 and game server 210 (i.e., when representations on client computer system 110 are different than representations on game server 210). For example, it may allow ongoing reconciliation to work in implementations in which game server 210 uses “double-precision” 64-bit floating-points (e.g., “binary64” as defined in the IEEE Standard for Floating-Point Arithmetic (“IEEE 754”)) and client computer system 110 uses “single-precision” 32-bit floating-points (e.g., “binary32” as defined in IEEE754) for their respective calculations. In some implementations, converting from floating-point to fixed-point may be different for different types of fields and/or different types of objects. In some implementations, a different number of bits (i.e., the “pre-defined number of most-significant bits” over which a hash may be calculated) may be used for different types of fields and/or objects.

In various implementations, game server 210 may be configured to send information related to a hash to client computer system 110. For example, game server 210 may be configured to send information related to hash pertaining to a certain group to client computer system 110. In some implementations, the information related to a hash may comprise a server time or timestamp indicating when the hash is/was valid.

In various implementations, client computer system 110 may be configured to calculate and/or maintain hashes of individual groups. For example, client computer system 110 may be configured to maintain a set of hashes pertaining to a single group to use the hashes to update data as necessary. In some implementations, client computer system 110 may be configured to calculate hashes in an incremental manner and/or as otherwise described herein with respect to game server 210.

In various implementations, upon receiving a hash from game server 210 associated with a given server time, client computer system 110 may be configured to compare the received hash with a hash calculated on client computer system 110 for the same server time. For example, the hash calculated on client computer system 110 may correspond to game server time as seen at client computer system 110, which may also be referred to as “server-T.” Further explanation regarding the time “server-T” and how it is calculated is provided in U.S. patent application Ser. No. 18/669,729. If the hashes are same, client computer system 110 may be within a margin of error defined by “pre-defined number of most significant bits.” If the hashes are different, client computer system 110 may be configured to issue a reconciliation request. In some implementations, a reconciliation request may be a parameter-less request. In some implementations, in response to a reconciliation request from client computer system 110, game server 210 may be configured to send a response back with an entire state of the game. A synchronization using such a response may be referred to herein as an “R0” synchronization model. In some implementations, a reconciliation request may comprise a list of sub-groups for which client computer system 110 requests reconciliation. In some implementations, client computer system 110 may be configured to include its own hashes of sub-groups (along with a server-T timestamp for when corresponding calculations were conducted) in the reconciliation request.

In various implementations, client computer system 110 may be configured to identify the portions of a virtual scene with matching hashes on client computer system 110 and game server 210 and the portions of the virtual scene with different hashes on client computer system 110 and game server 210. For portions of scene with the same hash, no additional action may be necessary. For portions with different hashes, the reconciliation request-response process may repeat to further narrow down (or identify) the portions of the virtual scene with different hashes. When differences are narrowed down sufficiently (e.g., down to one object or one specific field), game server 210 may be configured to send information regarding a state of the identified (narrowed down) sub-groups, which may correspond to one or more objects or one or more fields. Upon receiving the information, client computer system 110 may be configured to correct its own representation and/or may begin reconciling between an already-rendered state and a game state indicated in the information received from game server 210.

In some implementations, only one round of communication (i.e., a reconciliation request by client computer system 110 followed by a response from game server 210) may be needed to identify mis-matching parts (i.e., portions of the virtual scene with different hashes). A synchronization in such an implementation may referred to herein as an “R1” synchronization model, with two rounds of communication being referred to as a “R2” synchronization model, and so on. While more rounds of communication may help optimize traffic, too many rounds of communication may be undesirable (e.g., due to increased latencies).

In some implementations, game server 210 and client computer system 110 may be configured to calculate, send, and compare more than one hash for each group. For example, each of game server 210 and client computer system 110 may be configured to calculate hashes for different numbers of most significant bits (or digits with some radix). For example, in an example implementation, one calculation (hash1) may be for 10 significant bits, and a second calculation (hash2) may be for 8 significant bits. In such an implementation, depending on the different hashes that match or mismatch, a different synchronization model may be used (i.e., a R0, R1, R2 . . . or RN synchronization model). For example, there may be a case when hash1 is different but hash2 is the same between client computer system 110 and game server 210. In such a circumstance, the discrepancy between client computer system 110 and game server 210 would necessarily be small. As such, a slower synchronization model (such as R4) requiring more round-trips) may be used. In another example implementation, if both hash1 and hash2 are different, it is likely that the discrepancy between client computer system 110 and game server 210 is much larger. Thus, in such a circumstance, a faster synchronization model (such as R2) may be utilized.

In some implementations, hashes over most significant bits (or digits) may be calculated (by game server 210 and/or client computer system 110) with different rounding modes. For example, some hashes may be calculated using “rounding” (e.g., where for radix=10, “0.51” is rounded up and “0.49” is rounded down), and some hashes may be calculated using “truncation” (e.g., where for radix=10, even “0.99” is rounded down). This approach may be used to reduce the number of times when “spurious” reconciliation is detected (i.e., when a field value is around 0.5 for rounding or when a field value is around 1.0 for truncation). In some implementations, hash1 may be “rounded,” and hash2 may be “truncated”, or vice versa.

In some implementations, one or more of hash1/hash2/hash3/ . . . /hashN values may be used as a concatenation of two hashes. In some implementations, one of the concatenated hashes may be calculated over the most significant bits/digits using rounding, and another may be calculated using truncation. More generally, two different values of delta may be used for the calculation of most significant bits/digits. In some implementations, rounding may be expressed via truncation, or truncation may be expressed via rounding. For example, 0.5 may be added to a field value before performing rounding or truncation. In an example implementation, rounding may be calculated using

$$rounding ( x ) = truncation ( x + delta ) ,$$

and truncation may be calculated using:

$$truncation ( x ) = rounding ( x - delta ) ,$$

where in each instance delta=0.5. In other example implementations, the same truncation (x+delta) and/or rounding (x-delta) functions may be used but with different values of delta (0<=delta<=1).

In various implementations, individual hashes of a concatenated set of hashes may be calculated over a bit-wise representation of fixed-point (integer) with different radixes. In some such implementations, radixes using co-prime numbers may be used. For example, a radix=2 (which may be a usual bit-oriented representation) may be used for one of the concatenated hashes described herein, and radix=3 for another of the concatenated hashes. In such an example implementation, one hash may be calculated over most-significant bits of representation with radix=2, and another hash may be calculated over (potentially a different number, but leading to roughly the same precision) of most-significant “trits” of the representation with radix=3, where “trit” is a digit for radix=3 representation, taking values 0, 1, 2, which may be represented, for example, as 2 bits.

In various implementations, when comparing concatenated hash values, if any of two concatenated hash values are same, the hash values may be considered to be same. In some implementations, concatenated hashes may be extended to concatenating multiple hashes. For example, rounding/truncation functions with values of delta as 0, ⅕, ⅖, ⅗, and ⅘ may be used for 5 hashes. When different radixes are used, radixes 2, 3, 5, 7, and 11 may be used. In implementations with concatenated hashes, if any of the concatenated values are the same, hashes may be considered to be the same. This may be in contrast to existing approaches in which, when using concatenated hashes, all concatenated values need to be the same for the concatenated hashes to be considered the same.

In some implementations, some or all of the reconciliation data exchanges described herein may be considered “slow” data and/or “piggy-backed,” as each are described in U.S. patent application Ser. No. 18/669,729. In some implementations, the techniques described herein for performing ongoing reconciliation may be used in combination with other techniques described in U.S. patent application Ser. No. 18/669,729. For example, it may be used together with “skipped” network ticks or with “tick-less” implementations.

While various operations are described herein as being performed by the client computer system 110 or the game server 210 (or one or more components of client computer system 110 or game server 210), it is to be understood that, unless explicitly indicated otherwise, each of the one or more operations described herein as being performed by a client computer system 110 could be performed by a game server 210 and that each of the operations described herein as being performed by a game server 210 could be performed by a client computer system 110.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., client computer system 110, processor(s) 112, game server 210, processor(s) 212, and/or other components). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination.

Electronic storage 130 may store software algorithms, information determined by processor(s) 112, 212, information received remotely, and/or other information that enables system 100 to function properly. For example, electronic storage 130 may store standard three-dimensional meshes or models, information relating to one or more three-dimensional meshes or models, velocity profiles, publication and/or subscription data, an indication of occurrences within an online game (e.g., in the form of lists) that do and do not cause major changes from the perspective of the player, pre-defined groupings of objects (e.g., for the purpose of providing aggregated information), and/or other information related to the systems and methods described herein.

Game server 210 may comprise a remote server configured to provide publications and game state data related to an online game comprising three-dimensional virtual scenes to client computer system 110. In some implementations, game server 210 may be configured to provide to client computer system 110 publications related to an online game that include cause three-dimensional object(s) to be rendered within a virtual scene. For example, a publication may cause a virtual scene to be constructed comprising at least one object to be generated based on a generic asset, a base texture, and assets received in response to a request. In various implementations, game server 210 may be configured as a server device (e.g., having one or more server blades, processors, etc.) and/or as another device capable of providing publications and game state data related to an online game to client computer system 110.

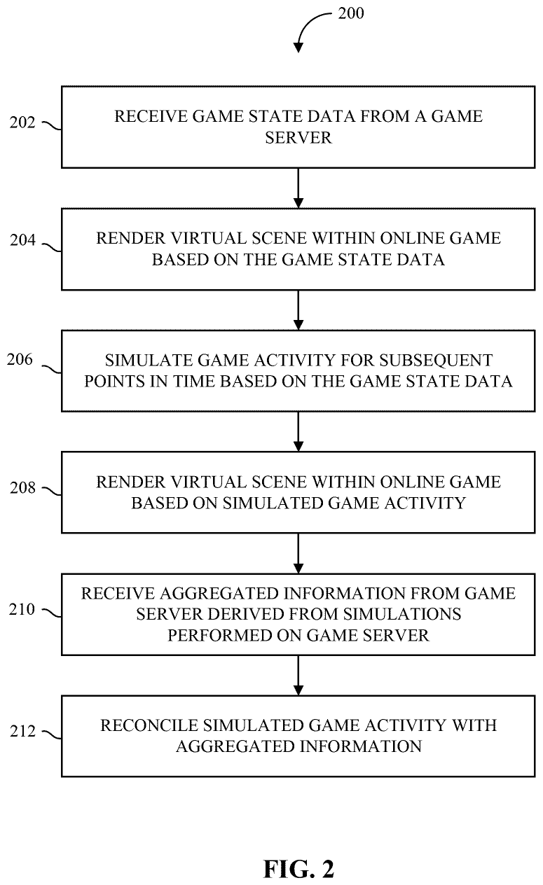

FIG. 2 illustrates an example of a process 200 for updating a game state based on information received from a game server, according to one or more aspects described herein. The operations of process 200 presented below are intended to be illustrative and, as such, should not be viewed as limiting. In some implementations, process 200 may be accomplished with one or more additional operations not described, and/or without one or more of the operations discussed. In some implementations, two or more of the operations of process 200 may occur substantially simultaneously. The described operations may be accomplished using some or all of the system components of client computer system 110 described in detail above.

In an operation 202, process 200 may include a client computer system receiving game state data from a game server. The game state data may be related to a first point in time in an online game. For example, the game state data may include coordinate data for an object in the virtual scene at a first point in time and velocity data for that object at the first point in time. In an operation 204, process 200 may include a client computer system rendering a virtual scene within the online game based on the game state data received from the game server. In an operation 206, process 200 may include the client computer system simulating game activity based on the game state data received from the game server. The simulation of the game activity may predict a game state at one or more subsequent points in time (i.e., after a first point in time to which the game state data received from the game server is related).

In an operation 208, process 200 may include the client computer system rendering a virtual scene within the online game based on the simulated game activity. In some implementations, the client computer system may only render virtual scenes based on simulations associated with certain types of occurrences. For example, game activity associated with an online game may include outcomes or developments. In various implementations, the client computer system may be configured to implement decisions reached based on simulations run on the client computer system according to a type of outcome or development associated with each decision. In some implementations, the client computer system may obtain a first list of occurrences comprising types of outcomes or developments within the online game that do not cause major changes from a perspective of a player and a second list of occurrences comprising types of outcomes or developments within the online game that do cause major changes from the perspective of the player. For example, in various implementations, the first and second list of occurrences may be hardcoded into a game client operating on the client computer system and may thus be obtained when the game client is downloaded onto the client computer system. In various implementations, implementing decisions according to a type of outcome or development associated with a decision comprises implementing decisions resulting in an occurrence on the first list of occurrences based solely on simulations performed on the client computer system and implementing decisions resulting in an occurrence on the second list of occurrences only upon receipt of information related to such a decision from the game server. Accordingly, a client computer system may be configured to render virtual scenes within the online game based only on simulations performed on the client computer system that include the types of outcomes or developments on the first list of occurrences.

In an operation 210, process 200 may include the client computer system receiving aggregated information related to the game state at the one or more subsequent points in time. The aggregated information may be derived from simulations performed on the game server. In various implementations, the aggregated information may comprise a hash of updated game state data generated based on simulations performed on the game server. For example, the hash may comprise a Fletcher checksum, a CRC checksum, a cryptographic hash function (such as SHA-256, SHA-3, or Blake2), and/or other types described herein. In some implementations, results of simulations performed on the game server may be represented in floating-point. In some such implementations, the game server may convert the floating-point representations to fixed-point representations before the hash is calculated based on the simulations performed on the game server. In various implementations, the hash may comprise a hash of only a portion of updated game state data. In various implementations, the hash may be calculated over a pre-defined number of digits (or bits, e.g., in the case of radix-2) of fields representing a game state at one or more subsequent points in time. For example, the pre-defined number of digits (or bits) may comprise a set of most-significant digits or bits. In some implementations, the hash may comprise a concatenation of multiple hash values. For example, the hash may comprise a concatenation of at least first and second hash values calculated based on the updated game state data. In some implementations, a concatenation of hash values may include hash values calculated over data which itself is calculated using different rounding techniques (e.g., rounding vs. truncating and/or using different delta values). For example, a first hash value may be calculated by truncating or rounding individual field values after adding a first delta, and a second hash value may be calculated by truncating or rounding the individual field values after adding a second delta. In some implementations, a concatenation of hash values may include hash values calculated using different radixes. For example, a first hash value may be calculated over at least one field value represented using a first radix of representation, and a second hash value may be calculated over the at least one field value represented using a second radix of representation. In such implementations, each radix of representation may comprise a co-prime radix. In some implementations, the aggregated information received from the game server may be related only to a portion of a game state at one or more subsequent points in time that is based on a pre-defined set of groupings of information making up the game state. In various implementations, the client computer system may be configured to receive aggregated information on a per-group basis over time. For example, the aggregated information received in operation 210 may relate to a first grouping of information, and the client computer system may be configured to receive aggregated information related to a second grouping of information after the aggregated information related to the first grouping of information.

In an operation 212, process 200 may include the client computer system reconciling the simulated game activity with the aggregated information received from the game server. In various implementations, reconciling the simulated game activity with the aggregated information may comprise comparing the simulated game activity with the aggregated information received from the game server and identifying any discrepancies between the simulated game activity and the aggregated information based on the comparison. In some implementations, when comparing concatenated hashes, hashes may be considered the same (and discrepancy may not be detected) if any of concatenated values are the same. In other words, in implementations in which the aggregated information comprises a hash of updated game state data generated based on the simulations performed on the game server and the hash comprises a concatenation of multiple hash values, comparing the simulated game activity with the aggregated information may comprise comparing a hash calculated on the client computer system with the concatenated hash values. In such implementations, a discrepancy may be identified only if none of the multiple hash values match the respective hash value calculated on the client computer system. Responsive to identifying a discrepancy, the client computer system may issue a reconciliation request to the game server. In some implementations, the reconciliation request may include aggregated information calculated by the client computer system. For example, the client computer system may be configured to calculated aggregated information related to a pre-defined sub-grouping of a grouping of information to which the aggregated information received from the game server was related. In such implementations, the pre-defined sub-grouping may be chosen based on the identified discrepancy between the simulated game activity and the aggregated information received from the game server. In various implementations, aggregated information calculated by the client computer system may itself comprise a hash of information based on simulations performed on the client computer system. In various implementations, the client computer system may receive a reply to the reconciliation request from the game server that includes information sufficient to reconcile the discrepancy between the simulated game activity and the aggregated information received from the game server.

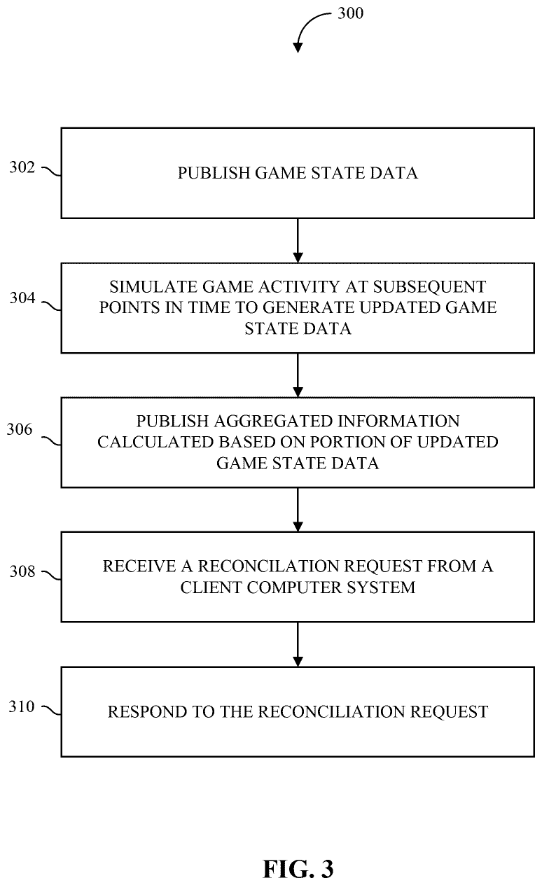

FIG. 3 illustrates an example of a process 300 for providing information related to a game state necessary to perform ongoing reconciliation of simulations performed at a game client, according to one or more aspects described herein. The operations of process 300 presented below are intended to be illustrative and, as such, should not be viewed as limiting. In some implementations, process 300 may be accomplished with one or more additional operations not described, and/or without one or more of the operations discussed. In some implementations, two or more of the operations of process 300 may occur substantially simultaneously. The described operations may be accomplished using some or all of the system components of game server 210 described in detail above.

In an operation 302, process 300 may include a game server publishing game state data for use by one or more client computer systems to render a virtual scene within an online game. The game state data may be related to a first point in time in an online game. For example, the game state data may include coordinate data for an object in the virtual scene at a first point in time and velocity data for that object at the first point in time.

In an operation 304, process 300 may include a game server simulating game activity for the online game at one or more subsequent points in time. The results of the simulations may comprise updated game state data.

In an operation 306, process 300 may include a game server publishing aggregated information calculated based on only a portion of the updated game state data. In various implementations, the aggregated information may comprise a hash calculated based on the portion of the updated game state data. For example, the hash may comprise a Fletcher checksum and/or other checksum or hash types described herein. In some implementations, the simulated game activity may be represented in floating-point. In some such implementations, the game server may convert the floating-point representations to fixed-point representations before the hash is calculated based on the simulations performed on the game server. In various implementations, the game sever may calculate the hash over a pre-defined number of digits (or bits, e.g., in the case of radix-2) of fields representing a game state at one or more subsequent points in time. For example, the pre-defined number of digits (or bits) may comprise a set of most-significant digits or bits. In some implementations, the hash may comprise a concatenation of multiple hash values. For example, the hash may comprise a concatenation of at least first and second hash values calculated based on the updated game state data. In some implementations, a concatenation of hash values may include hash values calculated over data which itself is calculated using different rounding techniques (e.g., rounding vs. truncating and/or using different delta values). For example, calculating a first hash value may include truncating or rounding individual field values after adding a first delta, and calculating a second hash value may include truncating or rounding the individual field values after adding a second delta. In some implementations, game server may calculate hash values within a concatenation of hash values using different radixes. For example, a first hash value may be calculated over at least one field value represented using a first radix of representation, and a second hash value may be calculated over the at least one field value represented using a second radix of representation. In such implementations, each radix of representation may comprise a co-prime radix. In some implementations, the aggregated information published by the game server may related only to a portion of a game state at one or more subsequent points in time that is based on a pre-defined set of groupings of information making up the game state. In various implementations, the game server may be configured to publish aggregated information on a per-group basis over time. For example, the aggregated information published in operation 306 may relate to a first grouping of information, and the game server may be configured to publish aggregated information related to a second grouping of information after the aggregated information related to the first grouping of information.

The aggregated information published by the game server in operation 306 may be provided for the purpose of enabling ongoing reconciliation of discrepancies between simulations performed on the client computer system and simulations performed on the game server. Thus, in an operation 308, process 300 may include the game server receiving a reconciliation request from a client computer system based on aggregated information published in operation 306. A reconciliation request may indicate a discrepancy between simulations performed on the client computer system and simulations performed on the game server that were identified by the client computer system based on the published aggregated information. In an operation 310, process 300 may include the game server responding to the reconciliation request. For example, in response to a reconciliation request, the game server may provide a reply that includes information sufficient to reconcile the discrepancy between the simulations performed on the client computer system and the aggregated information.

In some implementations, simulations run on game server may be necessarily provided to the client computer system. For example, in some implementations, a client computer systems may only render virtual scenes based on simulations associated with certain types of occurrences. For example, game activity associated with an online game may include outcomes or developments. In some implementations, the game server may be configured to provide a first list of occurrences comprising types of outcomes or developments within the online game that do not cause major changes from a perspective of a player (and which may be referred to herein as “soft occurrences”) and a second list of occurrences comprising types of outcomes or developments within the online game that do cause major changes from the perspective of the player (and which may be referred to herein as “hard occurrences”). In some other implementations, lists of types of occurrences may be already present on the client by the time when the client runs simulation (for example, they may be hardcoded into the game client operating on the client system). In some implementations, client computer systems may be prohibited from implementing decisions which belong to the types in the second list, while performing simulation. In other words, whenever the simulation on the client side leads to making a major decision for which a resulting occurrence is on the second list (such as a character falling off a cliff or a character collapsing because of their health decreasing), such a major decision may be ignored and may be implemented only when the client receives information regarding such a decision made on the server-side.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific example aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of digital processors, analog processors, digital circuits designed to process information, central processing units, graphics processing units, microcontrollers, microprocessors, field programmable gate arrays (FPGAs), application specific transformed circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112, 212 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112, 212 as well as data that may be manipulated by processor(s) 112, 212. The electronic storage may comprise floppy disks, hard disks, optical disks, tapes, or other storage media for storing computer-executable instructions and/or data.

Although illustrated in FIG. 1 as a single component, client computer system 110 and game server 210 may each include a plurality of individual components (e.g., computer devices) each programmed with at least some of the functions described herein. In this manner, some components of client computer system 110 and/or associated client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112, 212 include multiple processing units, one or more instructions may be executed remotely from the other instructions.

One or more components of system 100 may communicate with each other through hard-wired communication, wireless communication, or both. In various implementations, one or more components of system 100 may communicate with each other through a network. For example, client computer system 110 and/or game server 210 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Although client computer system 110, electronic storage 130, and game server 210 are shown to be connected to interface 102 in FIG. 1, any communication medium may be used to facilitate interaction between any components of system 100. For example, as referred to herein, interface 102 may comprise a network via which client computer system 110 may transmit packets or otherwise communicate with game server 210. In some implementations, the connections forming the network represented by interface 102 may include Asymmetric Digital Subscriber Line (ADSL), Symmetric Digital Subscriber Line (SDSL), cable, 3G, 4G, LTE, Ethernet, or any other existing or future developed systems and/or methods of communication with similar functionalities. In some implementations, one or multiple connections may be used to facilitate communication (e.g., transmit packets) between client computer system 110 and game server 210. Indeed, while described herein as a single interface 102 for simplicity, interface 102 may include one or multiple physical and/or virtual interfaces via which packets may be sent from client computer system 110 to game server 210, and vice versa. For example, multiple connections forming a Local Area Network (LAN), Intranet, or Internet may be used to facilitate communication between client computer system 110 and game server 210.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered example only, and the scope of the invention is accordingly intended to be limited only by the following claims.

1. A computer-implemented method of updating a game state based on information provided by a game server, the method comprising:
receiving, by a client computer system from a game server, game state data related to a first point in time in an online game;
rendering, by the client computer system, a virtual scene within the online game based on the game state data related to the first point in time;
simulating, by the client computer system, game activity based on the game state data related to the first point in time, wherein the simulated game activity predicts a game state at one or more subsequent points in time;
rendering, by the client computer system, a virtual scene within the online game based on the simulated game activity;
receiving, by the client computer system from the game server, aggregated information related to the game state at the one or more subsequent points in time, wherein the aggregated information is derived from simulations performed on the game server; and
reconciling, by the client computer system, the simulated game activity with the aggregated information received from the game server.

2. The computer-implemented method of claim 1, wherein the aggregated information comprises a hash of updated game state data generated based on the simulations performed on the game server.

3. The computer-implemented method of claim 2, wherein results of the simulations performed on the game server are represented in floating-point, and wherein the floating-point representations are converted to fixed-point representations before the hash is calculated based on the simulations performed on the game server.

4. The computer-implemented method of claim 2, wherein the hash comprises a hash of only a portion of the updated game state data.

5. The computer-implemented method of claim 4, wherein the hash is calculated over a pre-defined number of digits or bits of fields representing the game state at the one or more subsequent points in time.

6. The computer-implemented method of claim 5, wherein the hash comprises a concatenation of at least a first hash value and a second hash value.

7. The computer-implemented method of claim 6, wherein the first hash value is calculated by truncating individual field values after adding a first delta, and wherein the second hash value is calculated by truncating the individual field values after adding a second delta.

8. The computer-implemented method of claim 6, wherein the first hash value is calculated by rounding at least one field value after adding a first delta, and wherein the second hash value is calculated by rounding the at least one field value after adding a second delta.

9. The computer-implemented method of claim 6, wherein the first hash value is calculated over at least one field value represented using a first radix of representation, and wherein the second hash value is calculated over the at least one field value represented using a second radix of representation.

10. The computer-implemented method of claim 9, wherein the first radix of representation and the second radix of representation each comprise co-prime radixes.

11. The computer-implemented method of claim 2, wherein the hash comprises a Fletcher checksum.

12. The computer-implemented method of claim 1, wherein game activity associated with the online game includes outcomes or developments, the method further comprising implementing, by the client computer system, decisions according to a type of outcome or development associated with each decision.

13. The computer-implemented method of claim 12, wherein a first list of occurrences and a second list of occurrences are hardcoded at the client computer system, wherein the first list of occurrences comprises types of outcomes or developments within the online game that do not cause major changes from a perspective of a player, and wherein the second list of occurrences comprises types of outcomes or developments within the online game that do cause major changes from the perspective of the player.

14. The computer-implemented method of claim 13, wherein implementing decisions according to a type of outcome or development associated with each decision comprises implementing decisions resulting in an occurrence on the first list of occurrences based solely on simulations performed on the client computer system and implementing decisions resulting in an occurrence on the second list of occurrences only upon receipt of information related to such a decision from the game server.

15. The computer-implemented method of claim 1, wherein the aggregated information relates to only a portion of the game state at the one or more subsequent points in time, wherein the portion is based on a pre-defined set of groupings of information making up the game state.

16. The computer-implemented method of claim 15, wherein the aggregated information is related to a first grouping of information, wherein the method further comprises receiving, by the client computer system, aggregated information related to a second grouping of information, wherein the aggregated information related to the second grouping of information is received after the aggregated information related to the first grouping of information.

17. The computer-implemented method of claim 15, wherein reconciling the simulated game activity with the aggregated information received from the game server comprises:
comparing, by the client computer system, the simulated game activity with the aggregated information received from the game server;
identifying, by the client computer system, a discrepancy between the simulated game activity and the aggregated information received from the game server based on the comparison; and
responsive to identifying the discrepancy, issuing, by the client computer system, a reconciliation request to the game server.

18. The computer-implemented method of claim 17, wherein the aggregated information comprises a hash of updated game state data generated based on the simulations performed on the game server, wherein the hash comprises a concatenation of multiple hash values, and wherein comparing the simulated game activity with the aggregated information comprises comparing a hash calculated on the client computer system with the concatenated hash values, and wherein the discrepancy is identified only if none of the multiple hash values match the respective hash value calculated on the client computer system.

19. The computer-implemented method of claim 17, wherein the aggregated information is related to a first grouping of information, wherein the method further comprises:
calculating, by the client computer system, aggregated information related to a pre-defined sub-grouping of the first grouping of information, wherein the pre-defined sub-grouping of the first grouping of information is based on the identified discrepancy between the simulated game activity and the aggregated information received from the game server,
wherein the reconciliation request includes the aggregated information calculated by the client computer system.

20. The computer-implemented method of claim 19, wherein the aggregated information calculated by the client computer system comprises a hash of game state data generated based on the simulations performed on the client computer system.

21. The computer-implemented method of claim 17, the method further comprising:
receiving, by the client computer system from the game server, a reply to the reconciliation request, wherein the reply includes information sufficient to reconcile the discrepancy between the simulated game activity and the aggregated information received from the game server.

22. A system for updating a game state based on information provided by a game server, the system comprising:
a game client configured by computer readable instructions to:
receive, from a game server, game state data related to a first point in time in an online game;
render a virtual scene within the online game based on the game state data related to the first point in time;
simulate game activity based on the game state data related to the first point in time, wherein the simulated game activity predicts a game state at one or more subsequent points in time;
render a virtual scene within the online game based on the simulated game activity;
receive, from the game server, aggregated information related to the game state at the one or more subsequent points in time, wherein the aggregated information is derived from simulations performed on the game server; and
reconcile the simulated game activity with the aggregated information received from the game server.

23. The system of claim 22, wherein the aggregated information comprises a hash of updated game state data generated based on the simulations performed on the game server.

24. The system of claim 23, wherein results of the simulations performed on the game server are represented in floating-point, and wherein the floating-point representations are converted to fixed-point representations before the hash is calculated based on the simulations performed on the game server.

25. The system of claim 23, wherein the hash comprises a hash of only a portion of the updated game state data.

26. The system of claim 25, wherein the hash is calculated over a pre-defined number of digits or bits of fields representing the game state at the one or more subsequent points in time.

27. The system of claim 26, wherein the hash comprises a concatenation of at least a first hash value and a second hash value.

28. The system of claim 27, wherein the first hash value is calculated by truncating individual field values after adding a first delta, and wherein the second hash value is calculated by truncating the individual field values after adding a second delta.

29. The system of claim 27, wherein the first hash value is calculated by rounding at least one field value after adding a first delta, and wherein the second hash value is calculated by rounding the at least one field value after adding a second delta.

30. The system of claim 27, wherein the first hash value is calculated over at least one field value represented using a first radix of representation, and wherein the second hash value is calculated over the at least one field value represented using a second radix of representation.

31. The system of claim 30, wherein the first radix of representation and the second radix of representation each comprise co-prime radixes.

32. The system of claim 23, wherein the hash comprises a Fletcher checksum.

33. The system of claim 22, wherein game activity associated with the online game includes outcomes or developments, wherein the game client is further configured to implement decisions according to a type of outcome or development associated with each decision.

34. The system of claim 33, wherein a first list of occurrences and a second list of occurrences are hardcoded at the game client, wherein the first list of occurrences comprises types of outcomes or developments within the online game that do not cause major changes from a perspective of a player, and wherein the second list of occurrences comprises types of outcomes or developments within the online game that do cause major changes from the perspective of the player.

35. The system of claim 34, wherein to implement decisions according to a type of outcome or development associated with each decision, the game client is configured to implement decisions resulting in an occurrence on the first list of occurrences based solely on simulations performed on the game client and implement decisions resulting in an occurrence on the second list of occurrences only upon receipt of information related to such a decision from the game server.

36. The system of claim 22, wherein the aggregated information relates to only a portion of the game state at the one or more subsequent points in time, wherein the portion is based on a pre-defined set of groupings of information making up the game state.

37. The system of claim 36, wherein the aggregated information is related to a first grouping of information, wherein the game client is further configured to receive aggregated information related to a second grouping of information, wherein the aggregated information related to the second grouping of information is received after the aggregated information related to the first grouping of information.

38. The system of claim 36, wherein to reconcile the simulated game activity with the aggregated information received from the game server, the game client is configured to:
compare the simulated game activity with the aggregated information received from the game server;
identify a discrepancy between the simulated game activity and the aggregated information received from the game server based on the comparison; and
responsive to identifying the discrepancy, issue a reconciliation request to the game server.

39. The system of claim 38, wherein the aggregated information comprises a hash of updated game state data generated based on the simulations performed on the game server, wherein the hash comprises a concatenation of multiple hash values, and wherein to compare the simulated game activity with the aggregated information, the game client is configured to compare a hash calculated on the game client with the concatenated hash values, and wherein the discrepancy is identified only if none of the multiple hash values match the respective hash value calculated on the game client.

40. The system of claim 38, wherein the aggregated information is related to a first grouping of information, wherein the game client is further configured to:
calculate aggregated information related to a pre-defined sub-grouping of the first grouping of information, wherein the pre-defined sub-grouping of the first grouping of information is based on the identified discrepancy between the simulated game activity and the aggregated information received from the game server,
wherein the reconciliation request includes the aggregated information calculated by the game client.

41. The system of claim 40, wherein the aggregated information calculated by the game client comprises a hash of game state data generated based on the simulations performed on the game client.

42. The system of claim 38, wherein the game client is further configured to receive, from the game server, a reply to the reconciliation request, wherein the reply includes information sufficient to reconcile the discrepancy between the simulated game activity and the aggregated information received from the game server.

43-72. (canceled)
